(19) United States
(12) Patent Application Publication
(10) Pub. No.: US 2017/0165743 A1
(43) Pub. Date: Jun. 15, 2017

(54) CO-CATALYSTS FOR POLYURETHANE COLD BOX BINDERS

(71) Applicant: ASK Chemicals GmbH, Hilden (DE)

(72) Inventors: Gunter SCHAFFER, Düsseldorf (DE); Christian PRIEBE, Wülfrath (DE); Michael ARNDT-ROSENAU, Dormagen (DE)

(21) Appl. No.: 15/327,157

(22) PCT Filed: Jul. 20, 2015
(86) PCT No.: PCT/DE2015/000360

§ 371 Date: Jan. 18, 2017

(30) Foreign Application Priority Data
Jul. 18, 2014 (DE) 10 2014 110 189.8

(51) Int. Cl. B22C 9/02; C08G 18/79; B22C 1/18; B22C 1/16; B22C 1/22; C08G 18/54; C08G 18/16

(52) U.S. Cl. CPC B22C 9/02; C08G 18/542; C08G 18/797; C08G 18/163; B22C 1/162; B22C 1/2273; B22C 1/2293; B22C 1/186; B22C 1/181

(57) ABSTRACT

The subject matter of the present invention is a binder system containing blocked tertiary amines or amidines as co-catalysts for a polyurethane cold-box application. It also relates to the molding material mixtures produced using such a binder system further comprising volatile tertiary amines, a method for producing the molding material mixtures, and the cores and molds made from the molding material mixtures according to the cold-box process.

The present invention relates to a binder system containing blocked tertiary amines or amidines as co-catalysts for a polyurethane cold box application. It also relates to the molding material mixtures produced using such a binder system further comprising volatile tertiary amines, a method for producing the molding material mixtures, and the cores and molds made from the molding material mixtures according to the cold box process.

### PRIOR ART AND PROBLEM OF THE INVENTION

Casting mold materials are essentially composed of molds or molds and cores, which form the negative shape of the casting to be produced. As a rule, these molds and cores are made of molding mixtures comprising in content at least one refractory material, for example quartz sand, as a refractory molding basic material and a suitable binder or a binder precursor, which imparts adequate mechanical strength to the casting mold after its removal from the molding tool. The molding mixture is filled into a suitable hollow mold, compacted and then hardened. The hardened binder ensures solid cohesion between the particles of the molding base material, so that the casting mold achieves the required mechanical stability.

In casting, molds form the outer walls for the casting; cores are used for forming cavities within the casting. In this process it is not obligatory for molds and cores to consist of the same material. For example, in the case of chilled work the external shaping of the castings is accomplished using permanent metal molds. A combination of molds and cores produced from molding mixtures of different compositions and using different methods is also possible. When for simplicity's sake only the term “mold” is used in the following, the statements equally apply to cores (and vice versa) that are based on the same molding material mixture and are produced by the same method.

The method of core production that has become known under the name of “cold box method” or “Ashland method” has achieved great significance in the casting industry.

In this process two-component polyurethane systems are used for bonding a refractory molding basic material. The polyol component consists of a polyol with at least two OH groups per molecule and the isocyanate component of a polyisocyanate with at least two NCO groups per molecule. The hardening of the binder system takes place with the aid of low-boiling volatile tertiary amines, which are passed through the molding material-binder system mixture as a gas or aerosol and serve as catalysts. A method of this type is described, for example, in U.S. Pat. No. 3,409,579.

For various reasons it is desirable for the catalyst-free molding material mixtures to have a very long processing time, i.e., that the two components of the two-component polyurethane system react with one another only when they come into contact with the catalyst. Premature uncatalyzed reaction can be detected through the fact that the strengths of molds and cores with increasing age of the catalyst-free molding material mixtures decrease, and after a certain time, fall below the value required for safe handling and good casting results.

We have suggested various countermeasures over the years. For example, U.S. Pat. No. 4,540,724 describes the addition of phosphorus halides to the isocyanate component, while US 20130299120 discloses a binder system containing substituted benzenes and naphthalenes to prevent premature hardening of the molding material mixture.

Conversely, the binders should harden fully as quickly as possible upon contact with the catalyst. It is also advantageous to keep the requirement for amine as low as possible. The main reasons for this are as follows:

The amines are classified as toxic, and the allowable workplace exposure limits are accordingly very low. In addition, the amines are characterized by a highly unpleasant odor. This makes it necessary to collect the amines after they emerge from the molding tool, whether at the locations provided for this or at leaky sites, by suction and then to remove them from the exhaust air. This is usually performed using flue gas scrubbers, in which the amine-loaded air is passed through a sulfuric acid solution and freed from amines in this way.

The amine can then be recovered from the solution and recycled for reuse. In addition, premature hardening by amine radicals in ambient air should be minimized. The savings on amine is also of financial interest. This is true, not only because of the reduced purchase volume, but also since the suction unit can be designed to be smaller, which in turn has positive effects on the purchase price as well as the ongoing operating costs.

There has been no lack of attempts to improve the composition of the binder in terms of minimizing the amine use insofar as possible, e.g., by using less acidic constituents or using special solvent combinations. However, these efforts repeatedly encountered boundaries, since often other important binder properties, for example the processing time or the strengths, were impaired by the measures selected.

Therefore the inventors took it as their task to improve polyurethane cold-box binders so that they require less amine for hardening than do previously known polyurethane cold-box binders.

### SUMMARY OF THE INVENTION

The above problems are solved by the binder system, the molding material mixture, the multi-component system and the process, as described in the independent claims. Advantageous further developments are the subject matter of the dependent claims, or are described in the following.

Thus the subject matter of the invention is, among other things, a binder system consisting of at least one of components (A) to (C) for curing molding material mixtures having
(A) at least one polyol component containing or consisting of a polyol with at least two OH groups per molecule, wherein the polyol component comprises or consists of at least one phenol resin;
(B) at least one isocyanate component containing or consisting of a polyisocyanate with at least two NCO groups per molecule;
(C) at least one blocked amine compound obtainable from the reaction of at least one tertiary amine and/or at least one tertiary amidine with at least one CH-acid compound, as co-catalyst;
   and after forming, using at least refractory molding base components, along with optionally one or more additional components such as solvents, especially for components (A) and/or (B), and additives, the addition of
(D) at least one volatile tertiary amine compound with a boiling point of less than 100° C. as catalyst.

At least components (C) and (D) are present, separately from one another, before curing if the solids mixture. Component (C) is preferably dissolved in component (A) before it is added. Components (A), (B) and (D) are preferably present separately from one another before combining.

The solids mixture according to the invention, immediately before or during curing, comprises
(A) at least one phenol resin;
(B) at least one isocyanate component;
(C) at least one blocked amine compound obtainable from the reaction of at least one tertiary amine and/or at least one tertiary amidine with at least one CH-acid compound, as co-catalyst;
(D) at least one volatile tertiary amine compound with a boiling point of less than 100° C. as catalyst.
(E) at least one refractory molding basic material.

The invention also concerns a method for making a mold or core comprising the following steps:
(a) mixing the binder components (A), (B) and (C) with the molding basic material (E) and any additives.
(b) placing the molding material mixture obtained in step (a) a molding tool,
(c) hardening the molding material mixture in the molding tool with addition of the volatile tertiary amine catalyst (D), and
(d) removing the hardened core or the mold from the molding tool.

### DETAILED DESCRIPTION OF THE INVENTION

The polyol component (A) contains phenol-aldehyde resin, abbreviated here as phenol resin. All conventionally used phenol compounds are suitable for producing the phenol resin.

In addition to unsubstituted phenols, substituted phenols or mixtures thereof may be used. The phenol compounds are preferably unsubstituted either in both ortho positions or in one ortho and the para position. The remaining ring carbon atoms may be substituted. The selection of the substituents is not particularly limited as long as the substituent does not have an undesirable effect on the reaction of the phenol with the aldehyde. Examples of substituted phenols are alkyl-substituted, alkoxy-substituted, aryl-substituted and aryloxy-substituted phenols.

The above-named substituents have, for example 1 to 26, preferably 1 to 15 carbon atoms. Examples of suitable phenols are o-cresol, m-cresol, p-cresol, 3,5-xylenol, 3,4-xylenol, 3,4,5-trimethylphenol, 3-ethylphenol, 3,5-diethylphenol, p-butylphenol, 3,5-dibutylphenol, p-amylphenol, cyclohexylphenol, p-octylphenol, p-nonylphenol, cardanol, 3,5-dicyclohexylphenol, p-crotylphenol, p-phenylphenol, 3,5-dimethoxyphenol and p-phenoxyphenol.

Phenol itself is particularly preferred. More highly condensed phenols, such as bisphenol A, are also suitable. Also suitable are polyhydric phenols with more than one phenolic hydroxyl groups.

Preferred polyhydric phenols have 2 to 4 phenolic hydroxyl groups. Specific examples of suitable polyhydric phenols are pyrocatechol, resorcinol, hydroquinone, pyrogallol, phloroglucinol, 2,5-dimethylresorcinol, 4,5-dimethylresorcinol, 5-methylresorcinol or 5-ethylresorcinol. Mixtures of various monohydric and polyhydric and/or substituted and/or condensed phenol components may be used for producing the polyol component.

In one embodiment, phenols of general formula I:

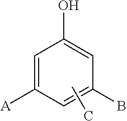

are used for producing the phenol resins, wherein A, B and C are selected, independently of one another, from: a hydrogen atom, a branched or unbranched alkyl group, which may have for example from 1 to 26, preferably from 1 to 15 carbon atoms, a branched or unbranched alkoxy group which may have for example from 1 to 26, preferably from 1 to 15 carbon atoms, a branched or unbranched alkenoxy group, which may have for example from 1 to 26, preferably from 1 to 15 carbon atoms, an aryl or aryl group, for example biphenyls.

Suitable aldehydes for producing the phenol resin component are aldehydes of the formula:

R—CHO,

wherein R is a hydrogen atom or a hydrocarbon atom residue with preferably 1 to 8, particularly preferably 1 to 3 carbon atoms. Specific examples are formaldehyde, acetaldehyde, propionaldehyde, furfuraldehyde and benzaldehyde. Particularly preferably, formaldehyde is used, either in its aqueous form, as paraformaldehyde, or trioxane.

To obtain the phenol resins, preferably an at least equivalent number of moles of aldehyde, based on the number of moles, of the phenol component, is used. Preferably the molar ratio of aldehyde to phenol amounts to 1:1.0 to 2.5:1, particularly preferably 1.1:1 to 2.2:1, especially preferably 1.2:1 to 2.0:1.

The phenol resin is prepared by methods known to the person skilled in the art. In this process the phenol and the aldehyde are reacted under essentially anhydrous conditions, especially in the presence of a divalent metal ion, at temperatures of preferably less than 130° C. The water formed is distilled off. For this purpose a suitable entrainment agent may be added to the reaction mixture, for example toluene or xylene, or the distillation is performed under reduced pressure.

The phenol resin is selected such that cross-linking with the isocyanate component (B) is possible. To build a network, phenol resins comprising molecules with at least two hydroxyl groups in the molecule are necessary.

According to U.S. Pat. No. 3,676,392 and U.S. Pat. No. 3,409,579, the phenol resins may be obtained by condensation of phenol with aldehydes, especially formaldehyde, in the liquid phase at temperatures up to about 130° C. in the presence of catalytic quantities of metal ions. The production of the phenol resins is also described in detail in U.S. Pat. No. 3,485,797. In addition to unsubstituted phenol, substituted phenols, preferably o-cresol and p-nonylphenol, may be used (see, for example, U.S. Pat. No. 4,590,229). According to EP 0177871 A2, phenol resins modified with monoalcohol groups with one to eight carbon atoms are used as additional components. Alkoxylation is believed to impart increased thermal stability to the binder systems.

Especially suitable phenol resins are known as “ortho-ortho” or “high-ortho” novolacs or benzyl ether resins. These can be obtained by condensation of phenols with aldehydes in weakly acidic medium using suitable catalysts. Suitable catalysts for producing benzyl ether resins are salts of divalent ions of metals, such as Mn, Zn, Cd, Mg, Co, Ni, Fe, Pb, Ca and Ba. Zinc acetate is preferably used. The quantity used is not critical. Typical quantities of metal catalysts are 0.02 to 0.3 wt.-%, preferably 0.02 to 0.15 wt.-%, based on the total quantity of phenol and aldehyde.

Such resins are described, for example, in U.S. Pat. No. 3,485,797 and in EP 1137500 B1, the disclosure of which is thus explicitly referenced in terms of both the resin itself and the production thereof, and incorporated in the disclosure content of this application.

According to an additional embodiment, modified phenol resins are used as binders or constituents of the binder, also known in the sense of the present invention as phenol resins. The modified phenol resin comprises phenol resin units that are substituted and/or linked by esters of orthosilicic acid, disilicic acid and/or one or more polysilicic acids. The modified phenol resin can be produced, e. g., by reacting the free hydroxy groups of a phenol resin with one or more esters of orthosilicic acid, disilicic acid and/or one or more polysilicic acids. Modified phenol resins in the sense of the present text are those that contain at least one structural unit of the formula A-Si, wherein A represents a phenol resin unit.

According to one embodiment, the silicon atom is bound to additional phenol resin units, wherein the phenol resin units may optionally also be linked with one another. The silicon atom can be additionally connected to one or more R—O groups, wherein R represents an organic residue, preferably branched or unbranched C1-C30-alkyl or aryl. The silicon atom is optionally further bound to additional silicon atoms via an oxygen bridge bond. In the modified phenol resins, individual, several, most of, or all of the said esters of orthosilicic acid, disilicic acid and polysilicic acid are bound to one, two, three, four or more phenol resin units of the modified phenol resin. Examples of modified phenol resins are reaction products of the free hydroxy groups of a phenol-formaldehyde novolak and/or a phenol-o-cresol-formaldehyde novolak with a tetra-alkyl ester of orthosilicic acid. Details on production and further examples are described in DE 102008055042 A1 (=US2011269902 A1) and therefore reference is made to these.

For example, for the isocyanate component (B), polyisocyanates as follows may be used:
Diisocyanates of an aromatic hydrocarbon with 6 to 15 carbon atoms,
Diisocyanates of an aromatic hydrocarbon with 4 to 15 carbon atoms,
Diisocyanates of a cycloaliphatic hydrocarbon with 6 to 15 carbon atoms.

Suitable polyisocyanates comprise aliphatic polyisocyanates, e.g., hexamethylene diisocyanate, alicyclic polyisocyanates such as 4,4′-dicyclohexylmethane diisocyanate and dimethyl derivatives thereof. Examples of suitable aromatic polyisocyanates are toluene-2,4-diisocyanate (TDI), toluene-2,6-diisocyanate, 1,5-naphthalene diisocyanate, triphenylmethane triisocyanate, xylylene diisocyanate and methyl derivatives thereof as well as polymethylene polyphenylisocyanates such as diphenylmethane-2,2′-diisocyanate (MDI), diphenylmethane-2,4′-diisocyanate (MDI) and/or diphenylmethane-4,4′-diisocyanate (MDI).

The polyisocyanates may also be derivatized in that divalent isocyanates are reacted with one another in such a manner that a portion of their isocyanate groups is derivatized to isocyanurate, biuret, allophanate, uretdione or carbodiimide groups. For example, the following are of interest: uretdione group-containing dimerization products, e.g., of methylenediphenyl diisocyanates (MDI) or toluene diisocyanates (TDI).

According to one embodiment, the polyisocyanates of the binder system used according to the invention comprise:
at least one aliphatic, cycloaliphatic or aromatic isocyanate, with a functionality of at least 2.0, which contains at least one uretoneimine and/or carbodiimide group,
optionally, in addition, one or more aliphatic, cycloaliphatic or aromatic polyisocyanate compound, preferably with 2 to 5 isocyanate groups that are free from uretoneimine and carbodiimide groups, and
optionally solvents.

The carbodiimide-modified and/or uretoneimine-containing isocyanates that may be used according to the invention can be obtained, e.g., by a catalytic reaction of isocyanate groups to form a carbodiimide group. This can react further with additional isocyanate groups (partially) to form a stable uretoneimine group. For this purpose, for example, two diisocyanates are reacted with two isocyanate groups to form a carbodiimide. Addition of a further diisocyanate results in formation of a uretoneimine group.

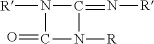

Suitable modified isocyanates are uretoneimine- and/or carbodiimide-modified 4,4′-diphenylmethane diisocyanates. But other isocyanates are also suitable. Typical commercial products are Lupranat MM 103, from BASF Polyurethane (carbodiimide-modified 4,4′-diphenylmethane diisocyanate) or Suprasec 4102, from Huntsmann (uretoneimine-modified MDI). These contain from 10 to 35 wt.-% uretoneimine- and/or carbodiimide-modified isocyanate compounds.

By introducing the uretoneimine and/or carbodiimide group, the cold resistance is also improved.

The isocyanate component can contain 0.2 to 35 wt.-%, preferably between 2 and 35 wt.-%, uretoneimine- and/or carbodiimide-modified isocyanate compounds.

Preferably the modified isocyanates are used in an isocyanate component with less than 40 wt.-% solvent, preferably less than 20 wt.-% solvent, especially less than 10 wt. % solvent, or even no solvent at all. However, applications with higher solvent quantities are also possible.

In general, 10 to 500 wt.-% isocyanate component based on the weight of the polyol component are used, preferably 45 to 300 wt.-%.

Preferably the isocyanate compounds, comprising the modified isocyanates, are used in a quantity such that the number of isocyanate groups amounts to from 80 to 120%, based on the number of free hydroxyl groups in the resin.

The polyol component and/or the isocyanate component (preferably both) of the binder system is preferably used in each case as a solution in an organic solvent or a combination of organic solvents. Solvents may be necessary, for example, to keep the components of the binder in a sufficiently low-viscosity state. This is necessary, among other things, to maintain uniform cross-linking of the refractory molding material.

Solvents that may be used for the polyol components include, for example, aromatic solvents used under the name of solvent naphtha as well as oxygen-rich, polar organic solvents. Especially suitable are dicarboxylic acid esters, glycol ether esters, glycol diesters, glycol diethers, cyclic ketones, cyclic esters (lactones), cyclic carbonates, silicic acid esters, oligomeric silicic acid esters or mixtures thereof. Dicarboxylic acid esters, cyclic ketones and cyclic carbonates are preferred.

The fraction of oxygen-rich polar solvents in components (A) and (B) can amount to 0 to 30%, especially 1 to 30%.

Preferred dicarboxylic acid esters have the formula R₁OOC—R₂—COOR₁, wherein R₁ in each case independently represents an alkyl group with 1 to 12, preferably 1 to 6, carbon atoms and R₂ is an alkylene group with 1 to 4 carbon atoms. Examples are dimethyl esters of carboxylic acids with 4 to 6 carbon atoms, which are available from DuPont under the name of “dibasic esters.” Phthalates are also suitable.

Preferred glycol ether esters have the formula R₃O—R₄—OOCR₅, wherein R₃ in each case is an alkyl group with 1 to 4 carbon atoms, R₄ is an alkylene group with 2 to 4 carbon atoms and R₅ is an alkyl group with 1 to 3 carbon atoms, e.g., butyl glycol acetate; glycol ether acetates are preferred.

Preferred glycol diesters correspondingly have the general formula R₃COO—R₄—OOCR₅, wherein R₃ to R₅ are defined as above and each of the residues is selected independently of one another (e.g., propylene glycol diacetate). Glycol diacetates are preferred. Glycol diethers can be characterized by the formula R₃—O—R₄—O—R₅, in which R₃ to R₅ are defined as above and each of the residues is selected independently of one another (e.g., dipropylene glycol dimethyl ether).

Preferred fatty acid esters, e.g., rapeseed fatty acid methyl ester or oleic acid butyl ester, cyclic esters and cyclic carbonates with 4 to 5 carbon atoms are also suitable (e.g., propylene carbonate). The alkyl and alkylene groups can in each case be branched or unbranched.

Solvents used for the isocyanate components are either (a) aromatic solvents, (b) the above-named polar solvents, or mixtures of (a) and (b). Fatty acid esters and silicic acid esters or oligomeric silicic acid esters, in each case by themselves or in a mixture with (a) and/or (b), are also suitable.

Solvents used for the polyol component are primarily mixtures of high-boiling-point polar solvents (e.g., esters and ketones) and high-boiling-point aromatic hydrocarbons. On the other hand, the isocyanate component is preferably dissolved in high-boiling-point aromatic hydrocarbons. In EP 0771599 A1 and WO 00/25957 A1, formulations are described in which aromatic solvents can be avoided entirely or almost entirely by using fatty acid esters.

Also suitable as solvents are the mixtures known from US 20130299120 consisting of
at least one alkyl/alkenyl benzene with a boiling point above 230° C., preferably above 250° C. and particularly preferably above 260° C. or even greater than 270° C. and
at least one dialkylated and/or dialkenylated naphthalene with a boiling point above 230° C., preferably above 250° C. and particularly preferably above 260° C. or even above 270° C.

In each case the boiling point is determined according to DIN 51761.

According to the invention, the binder (the curing composition) or the binder system (the components) comprises at least one blocked amine or blocked amidine as co-catalyst (C). At the usual processing temperatures of the polyurethane cold-box binder, i.e., of about 10° C. to about 45° C., the co-catalyst should exhibit no or only very little catalytic activity, so that the desired long processing time of the molding material mixture is maintained. This means that the co-catalyst must have a certain thermolatency. The blocked tertiary amine or blocked amidine is preferably liquid, i.e., free-flowing under its own weight, at 25° C.

Thermolatent catalysts for polyurethane systems are not new in principle. Best known and most frequently used are mercury compounds such as phenylmercury neodecanoate (Thorcat® 535 or Cocure® 44). Because of the high toxicity of mercury compounds, alternatives have long been sought.

In contrast to the cases known from the patent literature, the curing of the binder takes place during the addition of the volatile tertiary amine, but not necessarily while raising the temperature, preferably even without increasing the temperature, but the co-catalyst, interacting with the catalyst (D) increases the hardening of the catalyst so that raising the temperature is no longer absolutely necessary.

Surprisingly it was found that the presence of blocked amines or amidines in the molding material has a positive effect on the quantity of molding material mixture cured versus the quantity of volatile tertiary amine used as catalyst.

Blocked amines and amidines are known, for example, from WO 2011/095440. The blocked amines are produced by capping tertiary amines or amidines with CH-acidic compounds. Blocked amines are also sometimes called capped amines.

CH-acid compounds particularly suitable as blocking agents are acids or phenols (each respectively substituted), e.g., 2-ethylhexanoic acid, formic acid, acetic acid, methacrylic acid, trifluoroacetic acid, benzoic acid, cyanoacetic acid, 5-hydroxy-isophthalic acid, phenol, isocrotonic acid, phthalic acid, phosphoric acid, paratoluene, catechol/pyrocatechol, methyl salicylate, hydroxyacetophenone, especially o-hydroxyacetophenone. Particularly suitable are organic acids, such as 2-ethylhexanoic acid, formic acid, acetic acid, methacrylic acid, trifluoroacetic acid, benzoic acid, cyanoacetic acid, 5-hydroxy-isophthalic acid, isocrotonic acid and phthalic acid.

Particularly suitable as blocked amines are salts/adducts of 1,8-diazabicyclo[5.4.0]undec-7-ene (DBU), 1,4-diazabicyclo[2.2.2]octane (DABCO), and/or 1,5-diazabicyclo[4.3.0]-non-ene (DBN) with the above CH-acid compounds.

Examples of blocked amines are the commercially available products from Tosoh Corporation, Tokyo, Toyocat DB 30, Toyocat DB 40, Toyocat DB 41, Toyocat DB 60 and Toyocat DB 70, which differ in terms of applications technology by the degree of their thermolatency. This can be determined, for example, using differential thermal analysis (DSC) (see TEDA & TOYOCAT TECHNICAL DATA SHEET No. EE-003, Issue Date Sep. 2, 2004, Tosoh Corporation). These are solutions of tertiary amines and organic acids, partially in ethanediol. Because of the acid pH it is assumed that the acid component is present in molar excess. The fraction of the at least one co-catalyst (C) amounts to
generally about 0.1 to about 8 wt.-%, preferably about 0.2 to about 6 wt.-% and particularly preferably about 0.3 to about 4 wt.-%, relative to the total weight of the binder components (A) and (B) without additives to (A) or (B) or
generally about 0.05 to about 5 wt.-%, preferably about 0.05 to about 3 wt-% and particularly preferably about 0.1 to about 2 wt.-%, relative to the total weight of the binder components (A) and (B) including additives that are added to the binder components (A) and (B), such as solvents, silanes and other additives.

The co-catalyst can be used in a solvent. Suitable solvents are glycols, for example diethylene glycol or dipropylene glycol.

Particularly preferred volatile tertiary amines as catalysts (D) are, individually or in a mixture, dimethylethylamine, dimethyl-n-propylamine, dimethylisopropylamine, dimethyl-n-butylamine and triethylamine. These are used in gas form or as aerosols.

According to one embodiment, (C) and (A) are combined into one component, but it is also possible to use the two as separate components.

In addition to the already mentioned components, the binder systems can contain additives, e. g. silanes (e.g., according to EP 1137500 B1) or internal release agent, e. g. fatty alcohols (e.g., according to U.S. Pat. No. 4,602,069), drying oils (e.g., according to U.S. Pat. No. 4,268,425) or complexing agents (e.g., according to U.S. Pat. No. 5,447,968) or mixtures thereof.

Suitable silanes are, for example, aminosilanes, epoxysilanes, mercaptosilanes, hydroxysilanes and ureidosilanes, such as γ-hydroxypropyl trimethoxysilane, γ-aminopropyl trimethoxysilane, 3-ureidopropyl triethoxysilane, γ-mercaptopropyl trimethoxysilane, γ-glycidoxypropyl trimethoxysilane, β-(3,4-epoxycyclohexyl) trimethoxysilane and N-β-(aminoethyl)-γ-aminopropyl trimethoxysilane.

In addition the invention relates to molding material mixtures that comprise refractory molding basic materials and the components (A), (B) and (C) of the binder system, advantageously 0.1 to 5 wt.-%, preferably 0.2 to 4 wt.-%, particularly preferably 0.5 to 3 wt.-% of the binder system made of (A), (B) and (C), including any additives to (A), (B) or (C), such as solvents, or 0.05 to 5 wt.-%, preferably 0.05 to 3 wt.-%, especially preferably 0.1 to 2 wt. % of the binder system made of (A), (B) and (C) excluding any additives, in each case based on the weight of the refractory molding basic materials, to obtain a molding material mixture plus any additional additives;

as the refractory basic molding material (in the following called basic molding material for short), materials that are usual and known for the production of casting molds as well as mixtures thereof may be used. Suitable materials, for example, are quartz, zircon or chromite sand, olivine, vermiculite, bauxite, fireclay and so-called synthetic molding basic materials, thus molding basic materials that were brought by industrial methods of forming, into spherical or approximately spherical form (for example, ellipsoid) form. Examples of this are synthetic, spherical, ceramic sands—so-called Cerabeads® but also Spherichrome®, SpherOX®, and hollow microspheres such as those may, among other things, be isolated as components of fly ash.

Particularly preferred are molding basic materials that contain more than 50 wt.-% quartz sand based on the refractory molding basic material. Refractory molding basic materials are defined as substances that have a high melting point (melting temperature). Advantageously the melting point of the refractory molding basic material is greater than 600° C., preferably greater than 900° C., particularly preferably greater than 1200° C. and in particular preferably greater than 1500° C.

The refractory molding basic material advantageously constitutes more than 80 wt.-%, especially more than 90 wt.-%, particularly preferably more than 95 wt.-% of the molding material mixture. The refractory molding base material advantageously manifests a free-flowing state, especially to enable processing of the molding material mixture according to the invention in conventional core shooting machines.

The mean diameter of the refractory molding basic material is generally between 100 μm and 600 μm, preferably between 120 μm and 550 μm and particularly preferably between 150 μm and 500 μm. The particle size can be determined, e.g., by screening according to DIN ISO 3310. Particularly preferred are particle shapes with a ratio of greatest longitudinal extent to smallest longitudinal extent (perpendicular to one another and in each case for all directions in space) of 1:1 to 1:5 or 1:1 to 1:3, i.e., those that, for example, are not fibrous.

The invention also concerns a method for making a core or a mold, comprising at least the following steps:
(a) Mixing refractory molding basic materials (E) with the binder components (A) to (C) in a quantity of advantageously
   0.1 to 5 wt.-%, preferably 0.2 to 4 wt.-%, particularly preferably 0.5 to 3 wt.-% of the binder system made of (A), (B) and (C), including any additives to (A), (B) or (C), such as solvents, or
   0.05 to 5 wt.-%, preferably 0.05 to 3 wt.-%, especially preferably 0.1 to 2 wt.-% of the binder system made of (A), (B) and (C) excluding any additives, in
   each case based on the weight of the refractory molding basic material,
   to obtain a molding material mixture plus any additional additives;
(b) placing the molding material mixture obtained in step (a) in a molding tool,
(c) hardening the molding material mixture in the molding tool with addition of the volatile tertiary amine as catalyst (D) to obtain a core or a mold; and
(d) then removing the core or the casting mold from the tool and optionally hardening further.

For producing the molding material mixture, first the components of the binder system (with the exception of (D)) are combined and then added to the refractory molding basic material. However, it is also possible to add the components of the binder to the refractory molding basic material simultaneously or successively. The usual methods may be used to achieve simultaneous mixing of the components of the molding material mixture. The molding material mixture may additionally contain other conventional constituents, such as iron oxide, ground flax fibers,

According the invention the curing is performed using the PU cold-box method. For this purpose the catalyst is passed through the molded molding material mixture. The usual volatile tertiary amines employed in the area of the cold-box process can be used as the catalyst.

The molded articles produced with the method according to the invention can inherently have any shape usual in the casting area. In a preferred embodiment, the molded articles are present in the form of casting molds or cores. In addition, the invention relates to the use of said molded article for metal casting, especially iron or aluminum casting.

In the following, the invention will be explained on the basis of experimental examples without being limited thereto.

### EXAMPLES

### Experiment 1

Amine requirement: To 200 parts by weight (PW) quartz sand H32 (Quarzwerke Frechen) were added successively 0.6 PW each of the phenol resin solutions listed in Table 1 (all values given in PW) and the polyisocyanate components listed in Table 2 (all values given in PW) and mixed intensively in a laboratory mixer (Vogel and Schemmann AG). After the mixture had been mixed for 2 minutes, the molding material mixtures were transferred to the holding tank of a core shooting machine (Röperwerke Gieβereimaschinen GmbH) and from there introduced using compressed air (4 bar) into a cylindrical molding tool of 300 mm length and 50 mm diameter. Then 0.1 ml dimethylpropylamine (2 bar pressure, followed by 10 sec. flushing with air) were passed through the mold Immediately after the flushing, the mold was opened and the fraction of non-hardened molding material was removed. Then weighing was used to determine how much molding material mixture had been cured by the predetermined quantity of amine.

According to the invention, the binders are based on the compositions A2, A3, A5 and A6.

TABLE 1

| | A1 | A2 | A3 | A4 | A5 | A6 |
|---|---|---|---|---|---|---|
| Isocure 355^{a)} | 100 | 99 | 98.6 | | | |
| Ecocure 30 HE 1 LF^{b)} | | | | 100 | 99 | 98.6 |
| Toyocat DB 60^{c)} | | 1 | 1 | | 1 | 1 |
| Glyoxylic acid (50%)^{d)} | | | 0.4 | | | 0.4 |

^{a)}Commercial product ASK Chemicals GmbH, Hilden, primarily aromatic solvents
^{b)}Commercial product of ASK Chemicals GmbH, primarily polar solvents
^{c)}Tosoh Corporation, Tokyo
^{d)}Sigma Aldrich

TABLE 2

| | B1 | B2 | B3 | B4 |
|---|---|---|---|---|
| techn. MDI^{a)} | 79 | 79 | 80 | 80 |
| Solv. naphtha light^{b)} | 21 | 20.8 | | |
| Isopropyl laurate^{c)} | | | 20 | 19.8 |
| Phosphorus oxychloride^{d)} | | 0.2 | | 0.2 |

^{a)}Bayer Material Science GmbH
^{b)}Exxon AG
^{c)}Oleon GmbH
^{d)}Sigma Aldrich

It was found that with unchanged quantity of gaseous amine, substantially more molding material mixture is cured than without co-catalyst. This offers the opportunity for desired reduction of gaseous amine. These statements apply both for binders with primarily aromatic solvents and for those in which the solvent composition is principally polar constituents, e.g., esters.

### Experiment 2: Strengths

First, molding material mixtures were produced as described in Experiment 1, part of them transferred to the holding tank of a core shooting machine, and from there introduced into a molding tool to produce so-called Georg Fischer test pieces. These are ashlar-shaped test pieces with dimensions of 220 mm×22.36 mm×22.36 mm. The molds were hardened by sparging with 0.5 ml dimethylpropylamine (2 bar pressure, followed by 10 sec. flushing with air). To determine the bending strengths, after predetermined times (30 sec. or 24 h after they were produced) the test pieces were placed in a Georg Fischer strength testing device, equipped with a three-point bending device (Simpson Technologies GmbH) and the strength leading to breakage of the test piece was measured.

The results are likewise listed in Tab. 3. It is apparent that the presence of a co-catalyst has no effect on the strength.

TABLE 3

| | Not | | | | | |
|---|---|---|---|---|---|---|
| | according to | | | | | |
| | invention | | according to invention | | | |
| | A1/B1 | A1/B2 | A2/B1 | A2/B2 | A3/B1 | A3/B2 |
| hardened | 724 | 629 | 1280 | 1265 | 900 | 895 |
| molding | | | | | | |
| material [g] | | | | | | |
| hardened | 100 | 87 | 177 | 175 | 124 | 124 |
| molding | | | | | | |
| material [%] | | | | | | |
| Bending | | | | | | |
| strengths | | | | | | |
| [N/cm²] | | | | | | |
| 30 sec. | 170 | 160 | 170 | 190 | 180 | 180 |
| 24 h | 390 | 390 | 400 | 420 | 410 | 400 |
| | Not | | | | | |
| | according to | | | | | |
| | invention | | according to invention | | | |
| | A4/B3 | A4/B4 | A5/B3 | A5/B4 | A6/B3 | A6/B4 |
| hardened | 1265 | 1123 | 1768 | 1824 | 1843 | 1838 |
| molding | | | | | | |
| material [g] | | | | | | |
| hardened | 100 | 89 | 140 | 144 | 146 | 145 |
| molding | | | | | | |
| material [%] | | | | | | |
| Bending | | | | | | |
| strengths | | | | | | |
| [N/cm²] | | | | | | |
| 30 sec. | 140 | 130 | 150 | 200 | 170 | 180 |
| 24 h | 260 | 260 | 280 | 300 | 270 | 290 |

1. A binder system, comprising:
(A) at least one polyol component having one or more polyols with at least two OH groups per molecule, wherein the polyol component comprises at least one phenol resin;
(B) at least one isocyanate component having one or more polyisocyanates each with at least two NCO groups per molecule;
(C) at least one blocked amine compound obtainable from the reaction of at least one tertiary amine and/or at least one amidine with at least one acid and/or one phenol, each of which may be substituted, as co-catalyst; and
(D) at least one volatile tertiary amine compound having a boiling point of below 100° C. as a catalyst.

2. The binder system according to claim 1, wherein the polyisocyanate comprises an aromatic polyisocyanate, especially a polymethylene polyphenyl polyisocyanate.

3. The binder system according to claim 1, wherein the polyisocyanate, contains at least one of: a uretoneimine group and a carbodiimide group, and is in particular a methylenediphenyl diisocyanate with at least one uretoneimine and/or carbodiimide group.

4. The binder system according to claim 1, wherein either component (A) or (B) comprises a solvent and the solvent is selected from the group consisting of: a silicic acid ester, of an oligomeric silicic acid ester, and mixtures thereof.

5. The binder system according to claim 1, wherein the phenol resin can be obtained by reacting a phenol compound with an aldehyde compound in weakly acidic medium using catalysts.

6. The binder system according to claim 5, wherein the catalyst is a zinc compound, especially zinc acetate dihydrate.

7. The binder system according to claim 5, wherein the phenol compound is selected from the group consisting of: phenol, o-cresol, p-cresol, bisphenol A, cardanol and combinations thereof.

8. The binder system according to claim 5, wherein the aldehyde compound is an aldehyde of the formula R—CHO, wherein R represents a hydrogen atom or a hydrocarbon residue with preferably 1 to 8, particularly preferably 1 to 3, carbon atoms.

9. The binder system according to claim 1, wherein the phenol resin is a benzyl ether resin.

10. The binder system according to claim 1, wherein components (A) to (C) are contained in the binder system as follows:
(A) 15 to 35 wt.-%, especially 20 to 40 wt.-%, phenol resin,
(B) 25 to 45 wt.-%, especially 35 to 50 wt.-%, polyisocyanate and
(C) 0.05 to 5 wt.-%, especially 0.1 to 3 wt.-%, co-catalyst and
preferably the remainder up to 100 wt.-%, if present, is solvent for (A) and/or (B).

11. The binder system according to claim 1, wherein the binder system is present as a 2- or more-component system and at least one component is the component (A) and at least one additional, separate component is component (B) and the co-catalyst (C) is a constituent of another, separate component or a constituent of component (A).

12. The binder system according to claim 1, wherein the acid and/or the phenol is selected from the group consisting of: 2-ethylhexanoic acid, formic acid, acetic acid, methacrylic acid, trifluoroacetic acid, benzoic acid, cyanoacetic acid, 5-hydroxy-isophthalic acid, phenol, isocrotonic acid, phthalic acid, phosphoric acid, catechol, methyl salicylate, hydroxyacetophenone, and combinations thereof.

13. The binder system according to claim 1,
wherein the volatile tertiary amine compound is used at 10 to 40 wt. % based on the total weight of the binder components (A), (B) and (C) including any additives to (A), (B) and/or (C), such as solvents; or at 5 to 20 wt.-%, based on the total weight of the binder components (A), (B) and (C) excluding any additives to (A), (B) and/or (C).

14. The binder system according to claim 13, wherein the volatile tertiary amine compound is selected from the group consisting of: dimethylethylamine, dimethyl-n-propylamine, dimethylisopropylamine, dimethyl-n-butylamine, triethylamine, trimethylamine, and combinations thereof.

15. The binder system according to claim 1, wherein the at least one tertiary amine compound for the preparation of Co-catalyst (C) is selected from the group consisting of: 1,8-diazabicyclo[5.4.0]undec-7-ene (DBU), 1,5-diazabicyclo[4.3.0]non-5-ene (DBN), 1,4-diazabicyclo[2.2.2]octane (DABCO), and combinations thereof.

16. The binder system according to claim 1, wherein the at least one blocked amine is liquid at 25° C. and/or is dissolved in a solvent.

17. A molding material mixture, comprising:
the binder system made of at least (A), (B), (C) and (D) according to claim 1; and
a refractory molding base material, wherein the refractory molding base material is selected from the group consisting of: quartz, zircon or chromite sand, olivine, vermiculite, bauxite, fireclay, glass beads, granular glass, aluminum silicate hollow microspheres and mixtures thereof.

18. The molding material mixture according to claim 17, wherein more than 80 wt.-%, advantageously more than 90 wt.-% and particularly preferably more than 95 wt.-% of the molding material mixture is refractory molding base material.

19. The molding material mixture according to claim 17, wherein the molding material mixture comprises:
(a) 0.1 to 5 wt.-%, preferably 0.2 to 4 wt.-%, particularly preferably 0.5 to 3 wt.-% of the binder system made of (A), (B) and (C), including any additives to (A), (B) or (C), such as solvents, based on the weight of the refractory molding base material; or
(b) 0.05 to 5 wt.-%, preferably 0.05 to 3 wt.-%, particularly preferably 0.1 to 2 wt.-% of the binder system made of (A), (B) and (C) excluding any additives, based on the weight of the refractory molding basic materials.

20. A method for making a mold or a core, comprising the steps of:
mixing refractory molding base material mixture with the binder system made of at least (A), (B) and (C) according to one or more of claims 1 to 12 to obtain a casting mixture;
placing the casting mixture obtained in a molding tool;
hardening the casting mixture in the molding tool with addition of a volatile tertiary amine compound (D) in the gaseous state according to claim 1, 13 or 14 to obtain a self-supporting mold; and
subsequently removing the hardened casting mold part from the tool, and optionally hardening further, to obtain a solid, hardened casting mold part.

21. The method according to claim 20, wherein the molding material mixture comprises either:
(a) 0.1 to 5 wt.-%, preferably 0.2 to 4 wt.-%, particularly preferably 0.5 to 3 wt.-% of the binder system made of (A), (B) and (C), including any additives to (A), (B) or (C), such as solvents, based on the weight of the refractory molding base material; or
(b) 0.05 to 5 wt.-%, preferably 0.05 to 3 wt.-%, particularly preferably 0.1 to 2 wt.-% of the binder system made of (A), (B) and (C) excluding any additives, based on the weight of the refractory molding basic materials, is used.

22. (canceled)
